(19) United States
(12) Patent Application Publication
(10) Pub. No.: US 2015/0067489 A1
(43) Pub. Date: Mar. 5, 2015

(54) ZOOMABLE PAGES FOR CONTINUOUS DIGITAL WRITING

(71) Applicant: Evernote Corporation, Redwood City, CA (US)

(72) Inventors: Benjamin O. Zotto, San Francisco, CA (US); Felipe Baytelman, San Francisco, CA (US); Joshua Taylor, Menlo Park, CA (US); Miki Setlur, San Francisco, CA (US); Andrei Alexander Thorp, Uxbridge (CA); Quintin Carlson, Ponte Vedra, FL (US)

(21) Appl. No.: 14/447,738

(22) Filed: Jul. 31, 2014

Related U.S. Application Data
(60) Provisional application No. 61/873,481, filed on Sep. 4, 2013.

(51) Int. Cl. G06F 17/24; G06F 3/0488

(52) U.S. Cl. CPC G06F 17/24; G06F 3/0488; G09G 2340/12; G06T 2210/62
USPC 715/268

(57) ABSTRACT

Facilitating digital writing on a tablet screen includes providing a viewing screen corresponding to the tablet screen, superimposing on the viewing screen an authoring screen for a user to provide digital writing, the authoring screen being a magnified portion of the viewing screen, showing a mapping portion on the viewing screen, where the mapping portion corresponds to the portion of the viewing screen being magnified into the authoring screen, and projecting on to the viewing screen writing entered by the user in the authoring screen. The authoring screen is semi-transparent and writing and the mapping portion on the viewing screen are viewable through the authoring screen. The authoring screen may be superimposed over an entirety of the viewing screen. Writing provided on the viewing screen may be presented as faded strokes. A user may pan the authoring screen to facilitate entering writing into different parts of the viewing screen.

### CROSS-REFERENCE TO RELATED APPLICATIONS

This application claims priority to U.S. Prov. App. No. 61/873,481, filed Sep. 4, 2013, and entitled “ZOOMABLE PAGES FOR CONTINUOUS DIGITAL WRITING,” which is incorporated by reference herein.

### TECHNICAL FIELD

This application relates to the fields of data entry, data presentation and user interface, and more particularly to the field of automatic screen adaptation for handwritten data entry.

### BACKGROUND OF THE INVENTION

Hundreds of millions people are using tablets with multi-touch screens, such as Apple iPad, Samsung Galaxy Tab or Amazon Kindle Fire, in their everyday lives. According to market forecasts, tablet usage will rapidly increase; tablets are expected to outsell PCs globally in 2015, which is expected to see worldwide tablet shipments on all platforms in excess of 320 million units. Productivity applications for the tablet market are growing at an accelerated pace, with major productivity suites acquiring additional newly developed versions on key mobile platforms, including Android and iOS.

Virtually all contemporary multi-touch screens enable users to create and display user drawings and handwritten text. Users may write with finger(s) or utilize special styluses such as Wacom Bamboo Stylus, Adonit Jot and many other stylus models designed specifically for handwritten input on tablet screens, many of which are using projective capacitive touch technology. Software titles for handwritten note-taking and markup, such as Evernote Penultimate, Evernote Skitch, Notability, Notepad+, GoodNotes, Noteshelf, PDF Expert and many other programs that use writing on tablet screens for note-taking and annotation purpose have become popular on major mobile platforms and command millions of users each. Thus, in mid-July 2014, the top ten paid applications in the Apple App Store for iPad included six note-taking and annotation applications, each possessing a significant digital writing functionality.

In parallel with a fast growing demand, user interfaces (UIs) for handwritten note-taking are gaining increasing attention from researchers and developers. One of the most apparent usability challenges for multi-touch screens and handwriting note-taking software for tablet devices is a discrepancy between screen resolution parameters and other capabilities for viewing, on the one hand, and writing, on the other hand.

Thus, document readability on high resolution displays, such as an iPad retina display or a 1080p screen of a Google Nexus 7 tablet, may be comparable or even exceed that of traditional paper with an offset printing or conventional writing media. At the same time, for a variety of technological, ergonomic and other reasons, writing resolution and convenience for tablet screens and note-taking applications falls far behind that of conventional pen & paper note-taking Writing on a slippery screen with a finger or a primitive and bulky stylus may be clumsy and often prevents users from writing fast and from maintaining a normal small-to-medium size of handwritten letters. The currently prevailing set of capacitive and similar multi-touch screen technologies provide convenient and efficient finger manipulation of relatively large screen objects and quality performance of multi-touch gestures apparently at the expense of precise positioning of a writing instrument. Accordingly, accurate writing with normal size handwritten elements is virtually impossible. The effect of these writing difficulties is enlarged writing on tablet screens providing a degradation of informational capacity, which is several times lower for a full handwritten screen on a tablet compared with a sheet of paper of the same size filled with a traditional handwriting. Decreased information density causes, in turn, further slowdown of digital handwritten note-taking because of the necessity to frequently change screen filled with handwriting. The same deficiencies of digital writing on contemporary tablet screens are undermining handwritten charting capability and bring additional challenges to formatting, presentation and appearance of handwritten documents.

In order to cope with the aforementioned mismatch between viewing and authoring of handwritten notes, many tablet applications, including Notability, Notes Plus, Noteshelf, and Note Taker HD, offer a special user interface feature called in different applications a magnified view, a zoom-in mode, a zoom-in window, a close-up mode, etc. The feature may be implemented as an additional pop-up window on top of a handwritten note page where users may write in a larger size; as the users scribble in a close-up window, their handwriting is instantly scaled down and placed on a main note page outside the close-up window. Different flavors of close-up windows may offer various additional modes and settings, such as an automatic progression of a window upon reaching a margin thereof, a user-defined zoom-out factor, a carriage return causing a next portion of handwriting to start on a new line, a wrist protection option allowing to rest one's wrist on a screen while writing in a close-up window, etc.

In spite of an increased writing convenience offered by close-up windows with magnified views, they often present users with new challenges. In many cases, a default size of a close-up window offers insufficient space for fluid freehand writing. At the same time, increasing window size may conflict with visibility of handwritten notes on the main document viewing page, since the close-up window shields a significant portion of the scaled down content on the page. Additionally, positions of existing close-up windows may be disconnected from the corresponding portion of content on the main note page the close-up windows are used to author, which may cause a discrepancy between authoring and viewing handwritten input.

Accordingly, it is desirable to develop advanced systems and methods for a continuous digital writing offering in an intuitive and efficient combination of viewing and authoring capabilities for handwritten notes.

### SUMMARY OF THE INVENTION

According to the system described herein, facilitating digital writing on a tablet screen includes providing a viewing screen corresponding to the tablet screen, superimposing on the viewing screen an authoring screen for a user to provide digital writing, the authoring screen being a magnified portion of the viewing screen, showing a mapping portion on the viewing screen, where the mapping portion corresponds to the portion of the viewing screen being magnified into the authoring screen, and projecting on to the viewing screen writing entered by the user in the authoring screen, where the authoring screen is semi-transparent and writing and the mapping portion on the viewing screen are viewable through the authoring screen. The authoring screen may be superimposed over an entirety of the viewing screen. Writing provided on the viewing screen may be presented as faded strokes. A user may pan the authoring screen to facilitate entering writing into different parts of the viewing screen. The user may provide a multi-touch gesture to the viewing screen to position the mapping portion to facilitate entering writing into different parts of the viewing screen. The mapping portion may be a rectangle. The writing may be text. Facilitating digital writing on a tablet screen may also include auto-scrolling the viewing screen in a direction that is opposite to a natural writing direction of the user to provide free space for new text entered by the user. The natural writing direction may be left to right. Auto-scrolling may be provided only in response to detection of the user entering text. A speed of auto-scrolling may vary according to a speed at which the user enters text. A speed of auto-scrolling may be maintained to ensure that text is entered at central position of the authoring screen. Auto-scrolling may stop when a page boundary is reached by auto-scrolling. A user-actuable carriage control may be provided to facilitate page return to enter new text at a beginning point of a next line.

According further to the system described herein, a non-transitory computer-readable medium contains software that facilitates digital writing on a tablet screen having a viewing screen corresponding thereto. The software includes executable code that superimposes on the viewing screen an authoring screen for a user to provide digital writing, the authoring screen being a magnified portion of the viewing screen, executable code that shows a mapping portion on the viewing screen, where the mapping portion corresponds to the portion of the viewing screen being magnified into the authoring screen, and executable code that projects on to the viewing screen writing entered by the user in the authoring screen, where the authoring screen is semi-transparent and writing and the mapping portion on the viewing screen are viewable through the authoring screen. The authoring screen may be superimposed over an entirety of the viewing screen. Writing provided on the viewing screen may be presented as faded strokes. A user may pan the authoring screen to facilitate entering writing into different parts of the viewing screen. The user may provide a multi-touch gesture to the viewing screen to position the mapping portion to facilitate entering writing into different parts of the viewing screen. The mapping portion may be a rectangle. The writing may be text. The software may also include executable code that auto-scrolls the viewing screen in a direction that is opposite to a natural writing direction of the user to provide free space for new text entered by the user. The natural writing direction may be left to right. Auto-scrolling may be provided only in response to detection of the user entering text. A speed of auto-scrolling may vary according to a speed at which the user enters text. A speed of auto-scrolling may be maintained to ensure that text is entered at central position of the authoring screen. Auto-scrolling may stop when a page boundary is reached by auto-scrolling. A user-actuable carriage control may be provided to facilitate page return to enter new text at a beginning point of a next line.

The proposed system combines viewing and authoring pages within a full tablet screen and turns the screen into a single dual-function surface with auto-scrolling and additional control options.

At any time, a user may write and edit handwriting on the full screen, which is displayed to the user as an authoring page and is magnified to allow convenient writing with a finger or any type of digital stylus or pen. Handwritten strokes, i.e. elementary fragments of handwriting between a touch and a subsequent release in a touch-write-release cycle may be instantly scaled down and added to the viewing page, which is visible through the semi-transparent authoring screen as a set of faded strokes.

A visual model for the dual-function screen surface may be perceived as a full-screen note on a viewing page, which is subsequently magnified by a given factor. The device screen scrolls through that magnified page and allows writing and editing in a currently visible fragment of the enlarged screen, while the original viewing page may be displayed through a semi-transparent film separating the two screen views.

A current authoring screen, that is, an enlarged fragment of the note page displayed on the device screen, is mapped onto the scaled-down viewing page and a corresponding mapping portion (e.g., a mapping rectangle) is also shown to the user. The mapping portion constitutes an active area of the viewing page, since all newly entered handwriting, as well as edits made on a current authoring screen, instantly appear in a smaller size under the semi-transparent layer as faded handwritten fragments that are visible to the user.

A user may pan the magnified authoring screen, which causes the mapping portion to trace the position of the authoring screen within the viewing page. By looking at the main page view (viewing page), the user may quickly choose a position of the authoring screen for entering new content and editing existing content. Another navigational option may offer tapping or other pointing multi-touch gesture on the main viewing screen for instant positioning of the authoring screen at a needed location within the full-page screen.

The proposed system may offer an auto-scrolling feature, which facilitates a continuous natural writing and improves the ergonomics of note-taking. The auto-scrolling feature is activated by the system when the system detects writing of linear freehand text by the user, as opposed to doodling or charting. With auto-scrolling, the enlarged page is moved below a static authoring screen in a direction opposite to writing; or, equivalently, the authoring screen is moved along the enlarged note screen in the direction of writing. For a user entering a line of handwritten text that expands significantly beyond the authoring window (which is the case every time a user fills a significant portion of the viewing screen with handwriting, since the authoring screen is significantly smaller than the enlarger viewing screen), the auto-scrolling feature constantly provides a free space for a next word or symbol at or near a point where the user stops writing a previous fragment of text or near a center of a current line.

The auto-scrolling feature works as follows:
1. The system continuously analyzes user handwriting, discriminating between freehand text, on the one hand, and doodling or charting, on the other hand.
2. Whenever handwritten text is identified, the system calculates user writing speed along a current writing direction (which may be a horizontal line with writing direction left-to-right or right-to-left or a vertical line with a top-down or bottom-up writing).
3. The system may classify handwriting as either a slow or fast. Fast writing is characteristic for Western languages where each character is represented mostly by a small number of strokes quickly progressing from character to character and from word to word. Slow writing is a feature of some Far Eastern languages, especially with character depictions where a symbol consists of a large number of small strokes written in place.
4. In the event of slow handwriting, the system may drift the enlarged page in a direction opposite to handwriting, with a pre-defined maximum drifting speed characteristic for writers in a particular language and writing system, such as Kanji.
5. In the event of fast handwriting, the system may move the screen with the actual writing speed until the user stops writing. In many cases, writing stops either by a timeout or by interaction of the user with a user interface, such as by pressing a control button or making a multi-touch gesture.
6. If the user started writing at a point on a handwritten line where less than 50% of the width of authoring window is available as free space (for example, to the right of a line center in left-to-right languages), the system may continue moving the authoring page after the user has stopped writing to ensure that the right boundary (in left-to-right writing languages) of the most recently entered fragment of the handwritten text occupies the center position in the authoring window. In this way, the system provides that, when a user writes in the middle of a line of text, a regular interval of a free writing space taking at least a half of the corresponding dimension of the authoring window is available. For a better user experience, the system may decelerate idle moving speed after the user stops writing, shifting from writing speed to drifting speed and then halting the move.

Auto-scrolling may slow down to a halt when the authoring window meets an end of line (a page boundary) in the magnified window. In this case, a page margin may be displayed in the authoring window to indicate to the user the end of the line.

Another navigational feature for facilitating text entry in an authoring window is a carriage return control, which may be implemented via a clickable button, a multi-touch gesture or otherwise. The carriage return control moves the authoring window to the start of the next line of text, which may depend on horizontal and vertical writing directions. Thus, for languages with left-to-right, top-to-bottom text direction, carriage return moves the authoring window to the left margin of the next-to-bottom line. Vertical shift of the window may take into account calculated line heights and ensure displaying portions of the previously entered handwriting in the authoring window.

The proposed approach enhances a traditional static close-up window as it provides connected authoring and viewing pages where the user can instantly control the layout of the full page and is always aware of the exact positioning of the most recently entered or edited fragment of handwriting within the page layout.

Additionally, the auto-scrolling and carriage return features provide an optimal writing experience where a user may save a significant portion of muscular activity while moving a writing instrument across lines of handwritten text due to a balancing counter-movement of the page keeping the writing point approximately in the middle of the available line space.

### BRIEF DESCRIPTION OF THE DRAWINGS

Embodiments of the system described herein will now be explained in more detail in accordance with the figures of the drawings, which are briefly described as follows.

FIG. 1 is a schematic illustration of viewing, magnified and authoring screens, according to an embodiment of the system described herein.

FIG. 2 schematically illustrates mapping of an authoring screen onto a viewing screen, according to an embodiment of the system described herein.

FIG. 3 is a schematic illustration of a combined authoring and viewing display with a mapping portion, according to an embodiment of the system described herein.

FIGS. 4A-4B are schematic illustrations of auto-scrolling and carriage return features, according to an embodiment of the system described herein.

FIG. 5 is a system flow diagram illustrating system functioning, according to an embodiment of the system described herein.

### DETAILED DESCRIPTION OF VARIOUS EMBODIMENTS

The system described herein provides a mechanism for continuous writing on touch screens of tablets using a software emulated, spatially synchronized combination of an original page and a magnified page of a digital handwritten note to satisfy high resolution viewing requirement and simultaneously avoid limitations on digital writing imposed by touch technology, screen surface and other factors, such as supported in a Penultimate by Evernote software, developed by the Evernote Corporation of Redwood City, Calif. The system relies upon two-level screen viewing, manual selection of a fragment of a handwritten page for editing, displaying the fragment in both views using a mapping portion to indicate a position of the fragment on the viewing screen, automatic scrolling, carriage return and other features ensuring quality writing and viewing experiences.

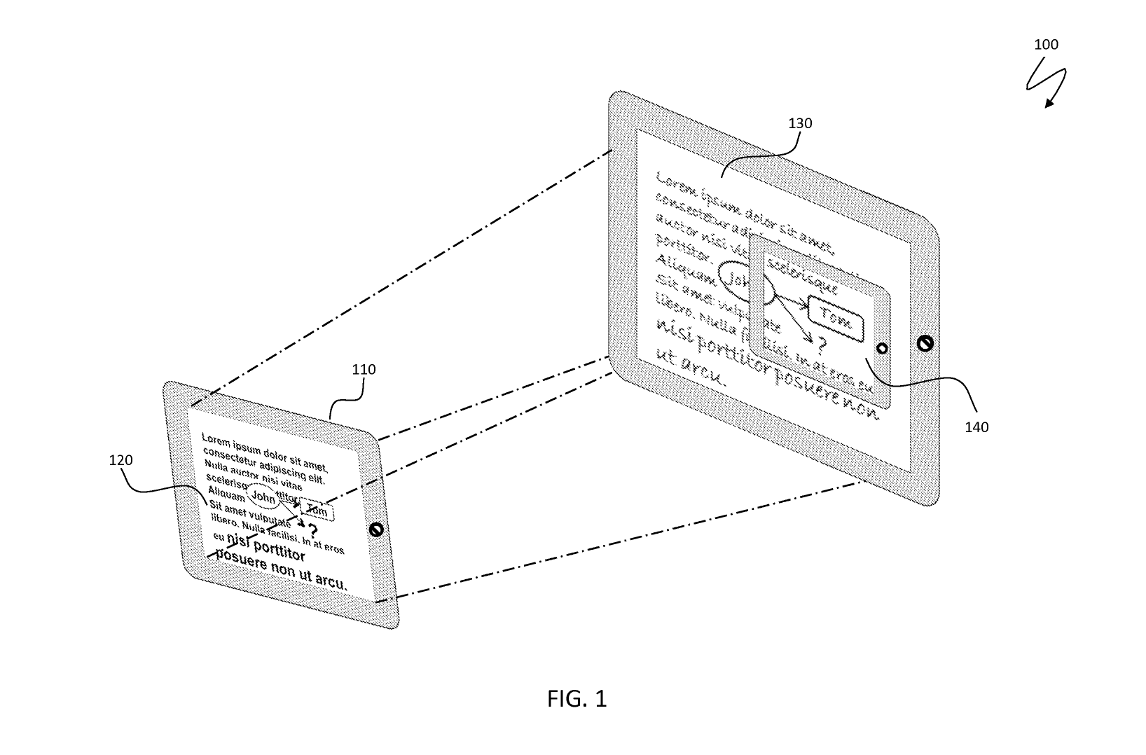

FIG. 1 is a schematic illustration 100 of viewing, magnified and authoring screens. A tablet device 110 displays a page 120 of a handwritten note on a screen of the tablet device 110. For continuous writing and note editing purpose, a virtual magnified copy 130 of the page is created (emulated by software). Accordingly, at any given time, the authoring screen 140 contains a magnified fragment of the screen. A magnifying factor, i.e. a size ratio between the screens 130, 120, may be preset in the software, calculated on the fly and suggested to a user based on a typical size of handwritten strokes entered by the user or chosen manually by the user.

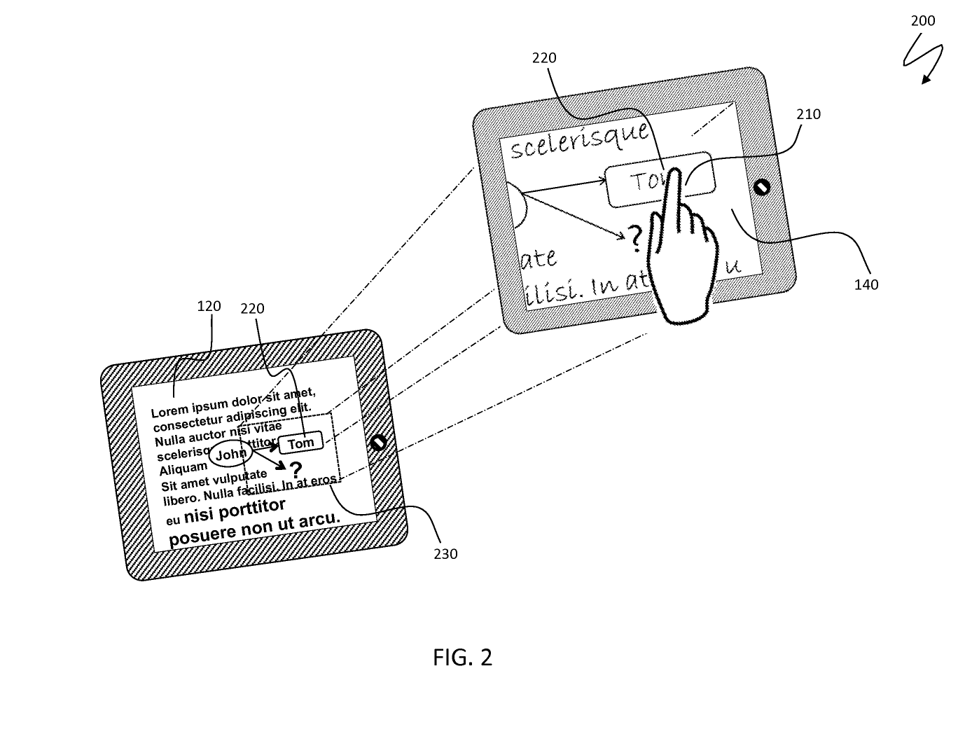

FIG. 2 is a schematic illustration 200 of mapping the authoring screen 140 onto the viewing screen 120. A fragment of handwritten note displayed on the viewing screen 120 is currently displayed on the authoring screen 140. The content of the authoring screen 140 is modified or augmented by the user; in the example shown in FIG. 2, the user writes on a touch screen with a finger 210 of the user. As the user conveniently enters strokes 220 on the enlarged authoring screen 140—in the example of FIG. 2, a cursive letter ‘m’ in a name ‘Tom’—the strokes 220 are scaled down by a reverse value of the magnifying factor and are instantly displayed on the viewing screen 120 where the strokes 220 are projected. Accordingly, the authoring screen 140 is mapped back onto the viewing screen 120 and a mapped image of the authoring screen 140 is identified by a mapping portion 230. The mapping portion 230 may be a rectangle.

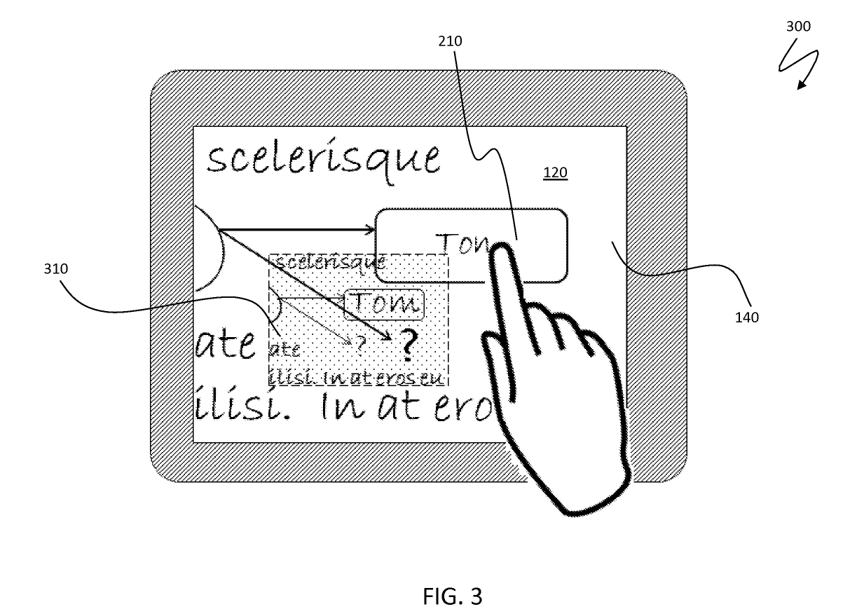

FIG. 3 is a schematic illustration 300 of a combined authoring and viewing display with a mapping rectangle 310. Analogously to FIG. 2, the authoring screen 140 is being modified by a user and a stroke is shown entered via the finger 210 of the user. The stroke is instantly scaled down and placed on the viewing screen 120, which is shown through the authoring screen 140, which is semi-transparent, or, more specifically, into the mapping rectangle 310 which is indicated by a dashed frame and is shown in faded strokes like the rest of the viewing screen 120. For an illustrative purpose, only strokes of the viewing screen 120 within the mapping rectangle 310 are shown in FIG. 3 and a semi-transparent layer is indicated by a filling of the mapping rectangle 310.

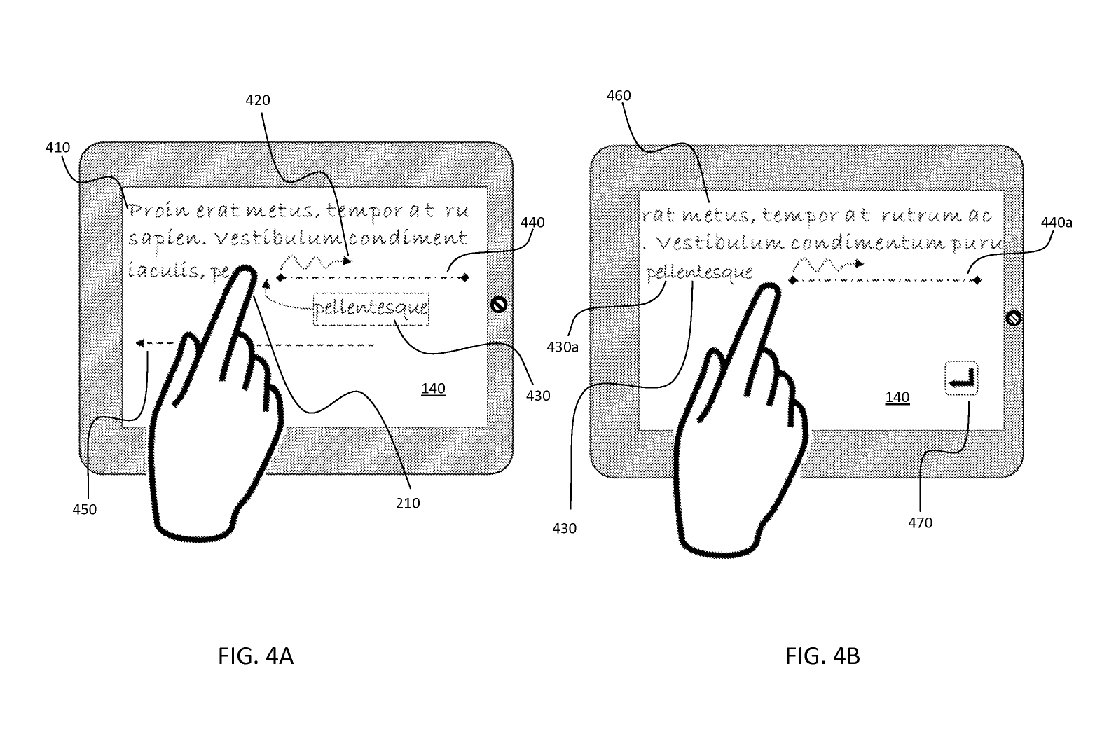

FIGS. 4A-4B are schematic illustrations of auto-scrolling and carriage return features. In FIG. 4A, a handwritten note on the authoring screen 140 is shown with its left margin in an original position, at a line start 410. A user writing with a finger 210 extends handwritten strokes to the right, as shown by a waving arrow 420. In the illustration of FIG. 4A, the user enters a handwritten word 430 (pellentesque) within a free line space 440; only a portion of the free line space 440 is indicated by the arrow 420; the rest of the free line space 440 may extend beyond the right margin of the authoring screen. As the user writes the word 430, the authoring screen 140 is moving to the left, in a direction 450, slightly slower than a horizontal writing speed of the user, so that muscular activity of the user is applied to writing letters of the word 430 almost in the same place on the authoring screen 140, without moving the wrist of the user too far to the right of the starting location of the finger 210.

FIG. 4B shows the status of the authoring screen 140 after the word 430 has been entered. The entered word occupies a position 430a within the shifted screen and note 460. Still, since the shift to the left of the authoring screen 140 was roughly equal to the length of the word 430, the finger 210 of the user remains approximately in a same position relative to the authoring screen 140 and a size of new free line space 440a within the authoring screen 140 is almost unchanged compared with the FIG. 4A.

As explained elsewhere herein, when the user approaches a right page margin (in case of the left-to-right writing), progression of the authoring screen 140 to the left may gradually slow down to a halt, and once the right page margin or the free space indicating the end of the line (in case the margin is invisible) appears on the authoring screen 140, the user continues writing in a regular mode moving the wrist of the user toward the margin. Such implementation may be preferred by users who might consider moving the page margin to the center of the authoring screen counter-intuitive.

FIG. 4B also shows a carriage return button 470. Tapping the button 470 at any time—for example, in case a user with a left-to-right note entry has finished writing of a paragraph before reaching the right page margin—may cause the screen to shift back to the left margin, i.e. to the line start 410. The page may also shift one text line up to allow the user continued writing near the horizontal screen median, in case the horizontal axis of the previous line was already near or below that median line.

In the event that the user did not use the carriage return button 470, but rather reached an end of the line during the continuous writing process, the system may automatically perform a carriage return function following the above procedure or may wait for the user to make a carriage return, pan the screen, or perform other actions.

Note that the mapping portion (rectangle) and viewing screen with faded scaled down strokes visible through a semi-transparent layer are not shown in FIGS. 4A, 4B for clarity of illustrations.

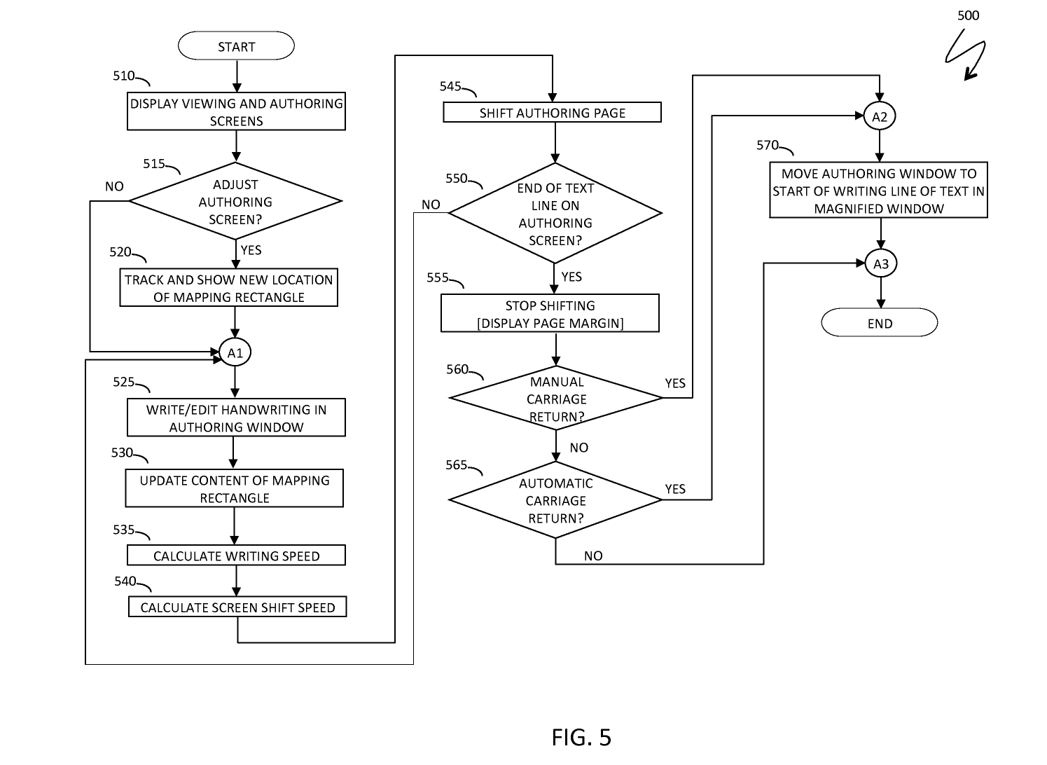

Referring to FIG. 5, a flow diagram 500 illustrates processing performed in connection with functioning of the system described herein. Processing starts at a step 510, where the system displays viewing and authoring screens. After the step 510, processing proceeds to a test step 515, where it is determined whether the user needs to adjust the authoring screen. If so, processing proceeds to a step 520, where the user pans or otherwise shifts the authoring screen, while simultaneously tracking and showing a new location of the mapping portion (rectangle). After the step 520, processing proceeds to a step 525, where the user writes or edits handwriting in the authoring window. Note that the step 525 may be directly reached from the step 515 if the user does not need adjusting the authoring screen. After the step 525, processing proceeds to a step 530, where the system scales down strokes entered by the user and adds strokes to the viewing screen, thus updating a content of the mapping portion (rectangle).

After the step 530, processing proceeds to a step 535, where the system calculates writing speed of the user. After the step 535, processing proceeds to a step 540, where the system calculates screen shift speed, as explained elsewhere herein in conjunction with the explanation 1-6 of auto-scrolling, above. After the step 540, processing proceeds to a step 545, where the system shifts the authoring page with a calculated shift speed in an opposite direction to a direction of writing by the user. After the step 545, processing proceeds to a test step 550, where it is determined whether the user has reached an end of a current line of text. If so, processing proceeds to a step 555 where the system stops shifting the page and a page margin may be displayed as a visual indicator of the end of the line; otherwise, processing proceeds back to the step 525.

After the step 555, processing proceeds to a test step 560, where it is determined whether the user pressed the manual carriage return button, made a corresponding multi-touch gesture or otherwise activated the manual carriage return, as explained elsewhere herein. If so, then processing proceeds to a step 570 where the authoring window is shifted to the starting position (e.g. left margin), as explained elsewhere herein and specifically in conjunction with FIG. 4B. If the manual carriage return at the step 560 was not detected, then processing proceeds to a test step 565, where it is determined whether the system settings provide for an automatic carriage return at the end of text lines. If so, processing proceeds to the step 570 to provide the automatic carriage return, explained elsewhere herein; otherwise, processing is complete. After the step 570, processing is complete.

Various embodiments discussed herein may be combined with each other in appropriate combinations in connection with the system described herein. Additionally, in some instances, the order of steps in the flowcharts, flow diagrams and/or described flow processing may be modified, where appropriate. Subsequently, elements and areas of screen described in screen layouts may vary from the illustrations presented herein. Further, various aspects of the system described herein may be implemented using software, hardware, a combination of software and hardware and/or other computer-implemented modules or devices having the described features and performing the described functions. The mobile device may be a tablet, although other devices, such as smartphones, are also possible. The system described herein may be implemented with any type of electronic screen capable of being actuated by a finger touch, capacitive, electromagnetic or other pen.

Note that mobile device(s) capable of running the system described herein may include software that is pre-loaded with the device, installed from an application store, installed from media such as a CD, DVD, etc., and/or downloaded from a Web site. The mobile device may use an operating system such as iOS, Android OS, Windows Phone OS, Blackberry OS and mobile versions of Linux OS.

Software implementations of the system described herein may include executable code that is stored in a computer readable medium and executed by one or more processors. The computer readable medium may be non-transitory and include a computer hard drive, ROM, RAM, flash memory, portable computer storage media such as a CD-ROM, a DVD-ROM, a flash drive, an SD card and/or other drive with, for example, a universal serial bus (USB) interface, and/or any other appropriate tangible or non-transitory computer readable medium or computer memory on which executable code may be stored and executed by a processor. The system described herein may be used in connection with any appropriate operating system.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

What is claimed is:

1. A method of facilitating digital writing on a tablet screen, comprising:
providing a viewing screen corresponding to the tablet screen;
superimposing on the viewing screen an authoring screen for a user to provide digital writing, the authoring screen being a magnified portion of the viewing screen;
showing a mapping portion on the viewing screen, wherein the mapping portion corresponds to the portion of the viewing screen being magnified into the authoring screen; and
projecting on to the viewing screen writing entered by the user in the authoring screen, wherein the authoring screen is semi-transparent and writing and the mapping portion on the viewing screen are viewable through the authoring screen.

2. A method, according to claim 1, wherein the authoring screen is superimposed over an entirety of the viewing screen.

3. A method, according to claim 1, wherein writing provided on the viewing screen is presented as faded strokes.

4. A method, according to claim 1, wherein a user pans the authoring screen to facilitate entering writing into different parts of the viewing screen.

5. A method, according to claim 1, wherein the user provides a multi-touch gesture to the viewing screen to position the mapping portion to facilitate entering writing into different parts of the viewing screen.

6. A method, according to claim 1, wherein the mapping portion is a rectangle.

7. A method, according to claim 1, wherein the writing is text.

8. A method, according to claim 7, further comprising:
auto-scrolling the viewing screen in a direction that is opposite to a natural writing direction of the user to provide free space for new text entered by the user.

9. A method, according to claim 8, wherein the natural writing direction is left to right.

10. A method, according to claim 8, wherein auto-scrolling is provided only in response to detection of the user entering text.

11. A method, according to claim 8, wherein a speed of auto-scrolling varies according to a speed at which the user enters text.

12. A method, according to claim 8, wherein a speed of auto-scrolling is maintained to ensure that text is entered at central position of the authoring screen.

13. A method, according to claim 8, wherein auto-scrolling stops when a page boundary is reached by auto-scrolling.

14. A method, according to claim 1, wherein a user-actuable carriage control is provided to facilitate page return to enter new text at a beginning point of a next line.

15. A non-transitory computer-readable medium containing software that facilitates digital writing on a tablet screen having a viewing screen corresponding thereto, the software comprising:
executable code that superimposes on the viewing screen an authoring screen for a user to provide digital writing, the authoring screen being a magnified portion of the viewing screen;
executable code that shows a mapping portion on the viewing screen, wherein the mapping portion corresponds to the portion of the viewing screen being magnified into the authoring screen; and
executable code that projects on to the viewing screen writing entered by the user in the authoring screen, wherein the authoring screen is semi-transparent and writing and the mapping portion on the viewing screen are viewable through the authoring screen.

16. A non-transitory computer-readable medium, according to claim 15, wherein the authoring screen is superimposed over an entirety of the viewing screen.

17. A non-transitory computer-readable medium, according to claim 15, wherein writing provided on the viewing screen is presented as faded strokes.

18. A non-transitory computer-readable medium, according to claim 15, wherein a user pans the authoring screen to facilitate entering writing into different parts of the viewing screen.

19. A non-transitory computer-readable medium, according to claim 15, wherein the user provides a multi-touch gesture to the viewing screen to position the mapping portion to facilitate entering writing into different parts of the viewing screen.

20. A non-transitory computer-readable medium, according to claim 15, wherein the mapping portion is a rectangle.

21. A non-transitory computer-readable medium, according to claim 15, wherein the writing is text.

22. A non-transitory computer-readable medium, according to claim 21, further comprising:
executable code that auto-scrolls the viewing screen in a direction that is opposite to a natural writing direction of the user to provide free space for new text entered by the user.

23. A non-transitory computer-readable medium, according to claim 22, wherein the natural writing direction is left to right.

24. A non-transitory computer-readable medium, according to claim 24, wherein auto-scrolling is provided only in response to detection of the user entering text.

25. A non-transitory computer-readable medium, according to claim 24, wherein a speed of auto-scrolling varies according to a speed at which the user enters text.

26. A non-transitory computer-readable medium, according to claim 24, wherein a speed of auto-scrolling is maintained to ensure that text is entered at central position of the authoring screen.

27. A non-transitory computer-readable medium, according to claim 24, wherein auto-scrolling stops when a page boundary is reached by auto-scrolling.

28. A non-transitory computer-readable medium, according to claim 15, wherein a user-actuable carriage control is provided to facilitate page return to enter new text at a beginning point of a next line.
